(19) United States
(12) Patent Application Publication
(10) Pub. No.: US 2016/0081766 A1
(43) Pub. Date: Mar. 24, 2016

(54) Corded Dental Handpiece

(71) Applicant: Young Innovations, Inc., Earth City, MO (US)

(72) Inventors: Matthew Wilson, Janesville, WI (US); Schuring Amanda, Gilberts, IL (US); Daniel Veile, St. Louis, MO (US); Vincent Vella, St. Louis, MO (US)

(21) Appl. No.: 14/860,887

(22) Filed: Sep. 22, 2015

Related U.S. Application Data
(60) Provisional application No. 62/054,174, filed on Sep. 23, 2014.

(51) Int. Cl. A61C 1/14; A61C 17/30; A61C 17/00; A61C 1/12; A61C 1/05

(52) U.S. Cl. CPC A61C 1/141; A61C 1/12; A61C 1/052; A61C 17/005; A61C 17/30

(57) ABSTRACT

An improved dental handpiece is described. The handpiece has a reverse radius grip and an angled bulkhead for attachment of a power cord.

### CROSS-REFERENCE TO RELATED APPLICATION

This application claims priority to U.S. Provisional Patent Application No. 62/054,174, filed on Sep. 23, 2014, the disclosure of which is incorporated herein by reference in its entirety.

### FIELD OF THE INVENTION

This invention is directed to a hand-held device for medical use, such as for dental use, and in particular for use in polishing teeth.

### BACKGROUND OF THE INVENTION

Dental tools are used by dental professionals use to provide dental treatment. The term “dental professional” for purposes of this application includes all dental professionals, including but not limited to a doctor of dental surgery, a periodontist, a dental hygienist, a dental assistant, a veterinarian, a veterinary dentist, or any other person who treats teeth for caries, plaque, tartar, or any other problems. The term “patient” means a being with teeth, and includes humans and non-humans, including but not limited to dogs, horses, or other animals who need dental treatment.

Dental tools are used to examine, manipulate, restore, and remove teeth and surrounding oral structures. Dental handpieces for purposes of this application are dental tools held and manipulated by hand by dental professionals, such as drills, lasers, cauterizers, probes, and polishers. A dental handpiece as is known in the prior art has three sections attached in this order: a neck section, a grip section, and a drive section. The drive section contains an electric motor or an air turbine. The motor or turbine turns a drive shaft that extends axially from the drive section through the grip section and into the neck section. The drive shaft has a driving gear at its forward end inside the neck section. The driving gear interacts with a driven gear located in the neck section. The driven gear rotates a tool attachment such as a drill, a burr, or a prophy angle. The motor or turbine need power and accordingly have a cord attached to the near end of the drive section, the cord either conveying electricity to the motor or compressed air to the turbine.

As dental handpieces are held by hand, properties such as weight, balance, and grip are important to the dental professionals who use the tools. The device needs to have light enough weight to be handled by a dental professional for long periods of time. The grip must allow for a secure grasp by the dental professional. Balance is important because the dental professional is generally doing precision work and needs to be able to manipulate the handpiece in a precise manner without the handpiece slipping.

The dental handpiece of the present invention supplies improved balance and grip as compared to the prior art.

### SUMMARY OF THE INVENTION

The preferred embodiment of the method of the present invention comprises an improved medical handpiece, in particular a dental handpiece, having a reverse radius grip and an angled bulkhead cord attachment.

### BRIEF DESCRIPTION OF THE DRAWINGS

The organization and manner of the structure and operation of the invention, together with further objects and advantages thereof, may best be understood by reference to the following description, taken in connection with the accompanying non-scale drawings, wherein like reference numerals identify like elements in which:

FIG. 1 is an assembly view of the handpiece of the preferred embodiment of the invention.

FIG. 2A is a top side view of the handpiece of FIG. 1.

FIG. 2B is a front side view of the handpiece of FIG. 1.

FIG. 2C is a left side view of the handpiece of FIG. 1.

FIG. 2D is a back side view of the handpiece of FIG. 1.

FIG. 2E is a right side view of the handpiece of FIG. 1.

FIG. 2F is a bottom side view of the handpiece of FIG. 1.

FIG. 3 is an exploded side view of the handpiece of FIG. 1, a prophy angle, and an air supply system.

FIG. 4A is another top side view of the handpiece of FIG. 11, a prophy angle, and an air supply system.

FIG. 4B is a cutaway view of the handpiece of FIG. 11, a prophy angle, and an air supply system.

FIG. 5 is an exploded view of the top side of the handpiece of FIG. 11, a prophy angle, and an air supply system.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein. The handpiece of the described embodiment is an air-powered dental handpiece intended for use by dental professionals to polish teeth with disposable prophy angles, but the invention can be used with any hand-held tool having a corded power source.

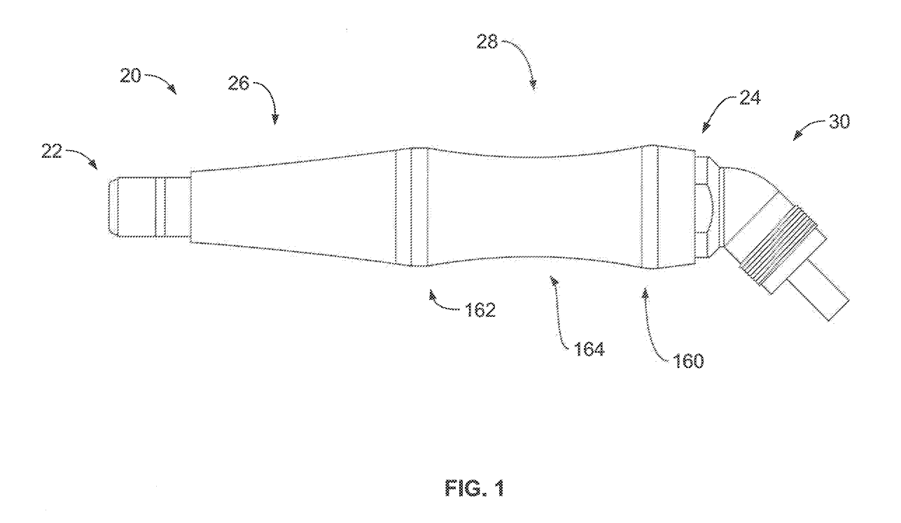

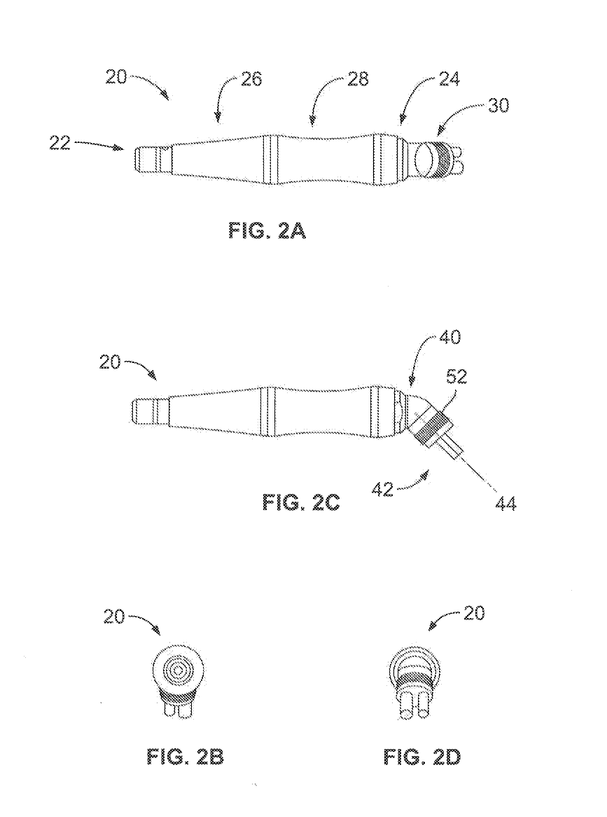

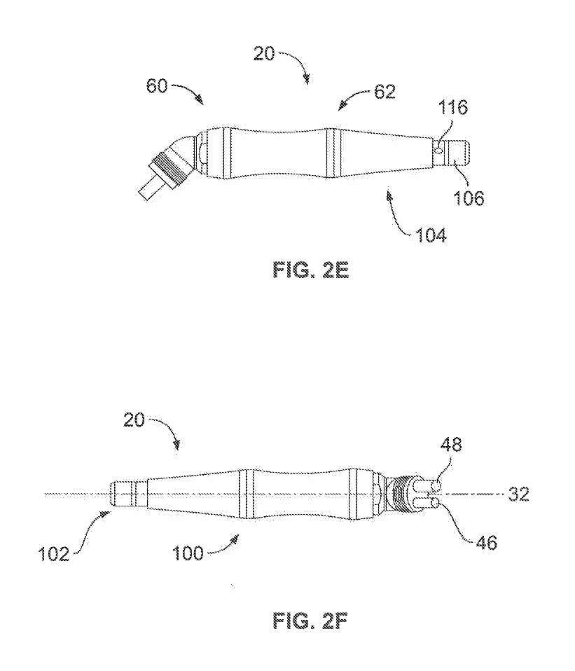

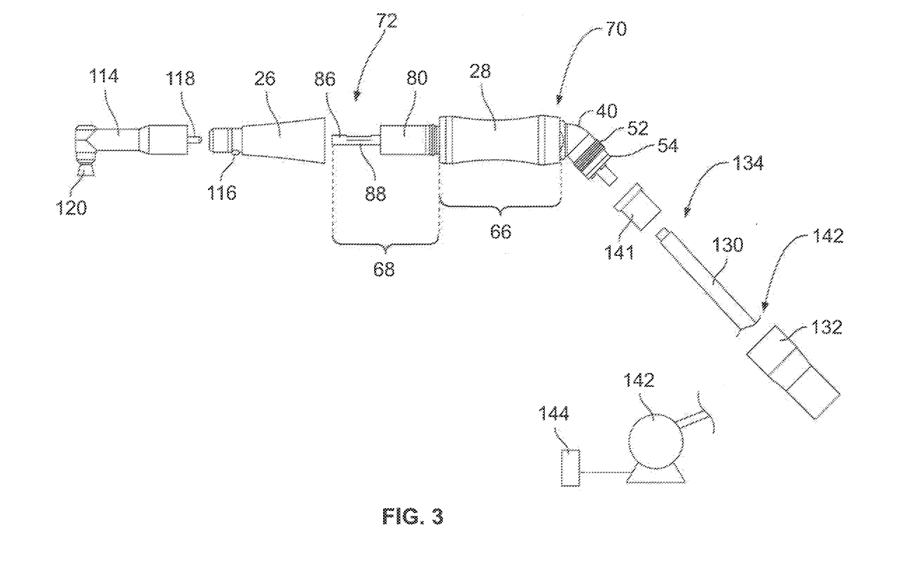

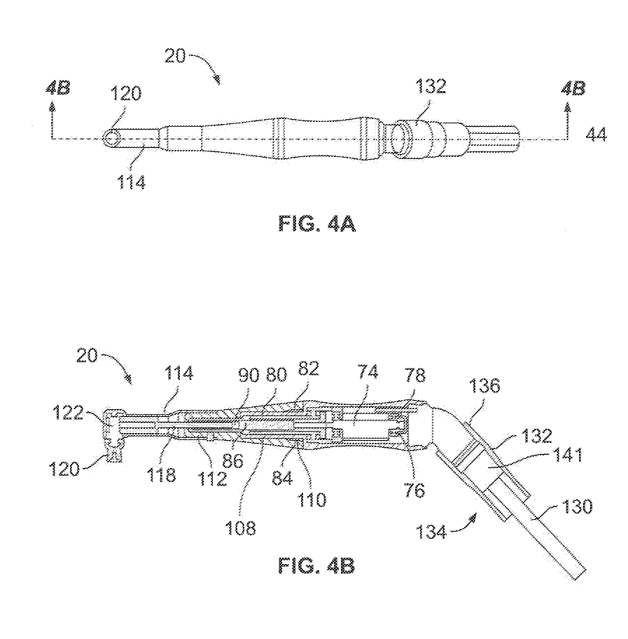

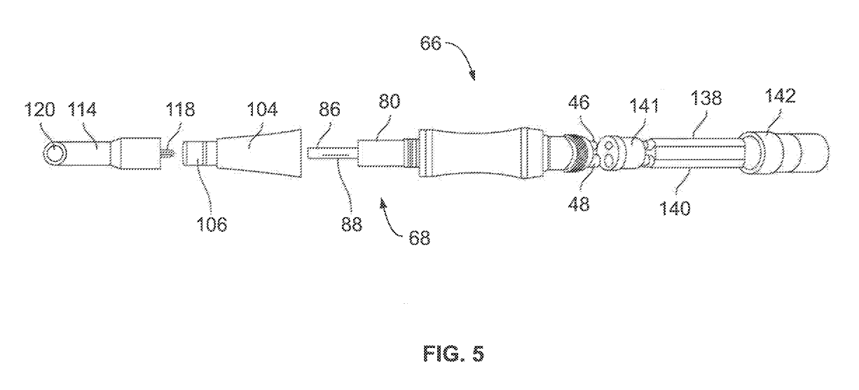

The handpiece 20 of the preferred embodiment of the invention is shown in FIGS. 1 through 5. Handpiece 20 is a structure having a distal end 22 and a proximal end 24. Handpiece 20 has three sections connected in this order, from distal end to proximal end: a nosecone 26, a power section 28, and a bulkhead section 30. A line 32 in shown in, for example, FIG. 2F, that extends axially through nosecone 26 and power section 28 and into bulkhead section 30 to show the arrangement of sections 26, 28, and 30.

Bulkhead section 30 is a hollow casing having a first end 40 proximal to power section 28 and a second end 42 distal to power section 28. Bulkhead section 30 is bent or at an angle relative to power section 28. A line 44 normal to second end 42 is shown in, for example, FIG. 2C. Preferably, line 44 is about 45 degrees from axial line 32.

An air supply tube 46 and an air exhaust tube 48 run through bulkhead section 30 from first end 40 to second end 42 and protrude slightly from each end 40, 42. A set of male threads 52 is spaced slightly inward of second end 42. A gasket 54 covers second end 42 except for tubes 46, 48, which protrude from second end 42.

Power section 28 has a first end 60 proximal to bulkhead section 30 and a second end 62 distal to bulkhead section 30. First end 40 of bulkhead section 30 is threaded into first end 60 of power section 28. Power section 28 has a gripping section 66 at first end 60 and an attachment section 68 at second end 62. Gripping section 66 has a first end 70 proximal to bulkhead section 30 and a second end 72 distal to bulkhead section 30. Gripping section 66 encloses an air turbine 74 with air intake port 76 and air exhaust port 78. Ports 76, 78 are configured to engage tubes 46, 48, respectively,

Attachment section 68 has a swivel surface 80 extending axially about line 32. Swivel surface 80 is a cylindrical tube with a circumferential slot 82 holding a key 84. Key 84, when placed in slot 82, has an outer diameter just greater than the outer diameter of swivel surface 80. Collet 86 extends from air turbine 70 axially through swivel surface 80 and is rotated by air turbine 70. Collet 86 is a cylindrical structure, solid at an end proximal to air turbine 70 and having a bore 90 at an end distal to air turbine 70. Crimped surfaces 88 extend into bore 90.

Nosecone 26 has a first end 100 proximal to power section 28 and a second end 102 distal to power section 28. Nosecone 28 has a conic section 104 at second end 102 and a chuck section 106 extending from conic section 104 to second end 102. Conic section 104 is a cone-shaped solid structure with a cylindrical bore 108 extending axially throughout conic section 104. Bore 108 has an inner diameter just slightly greater than the outer diameter of swivel surface 80, so that swivel surface 80 fits securely within bore 108 of conic section 104. Conic section 104 has a circumferential slot 110 configured to receive key 84. Nosecone 26 accordingly will attach securely to swivel surface 80 but is able to rotate circumferentially about axial line 32.

Chuck section 106 is a sold cylindrical structure having an axial bore 112 configured to hold collet 86. Bore 112 has an inner diameter sufficient to allow collet 86 to rotate freely within bore 112. Chuck section 106 has an outer diameter sufficient to hold a prophy angle 114 with a friction fit. Locator pin 116 protrudes radially from chuck section 106 and is configured to hold prophy angle 114 at a preselected location on nosecone 26.

Prophy angle 114 has a driving gear 118 which engages or fits into the bore 90 of collet 86. Crimped surfaces 88 produce a friction fit of driving gear 118 in bore 90. Accordingly, when collet 86 rotates, driving gear 118 rotates. The rotation of driving gear 118 rotates driven gear 122, which causes a prophy paste cup 120 to rotate in the manner known in the art of prophy angles.

Handpiece 20 is designed for use with an air tube 130. Air tube 130 has a first end 134 with a sleeve 132 at a first end 134. Sleeve 132 contains female threads 136 configured to mate or connect with second threads 52 of bulkhead section 30. Air tube 130 contains an air supply lumen 138 and an air exhaust lumen 140, configured to connect to air supply tube 46 and air exhaust tube 48, respectively, through coupler 141 when sleeve 132 is mated to bulkhead section 30. Air tube 130 attaches at a second end 142 to a compressed air supply system 144, controlled by a foot pedal 146. Air supply system 142 preferably supplies air at 40 to 45 psi.

Gripping section 66 has a novel configuration comprising three sections, a first section 160 proximal to bulkhead section 30, a third section 162 proximal to nosecone 26, and a middle section 164 between first section 160 and third section 162.

Middle section 164 has a reverse radius configuration, with a smallest radius of the middle section being less than the maximum radii of first section 160 and third section 162. The maximum radius of third section 162 is preferably 0.718 in. The maximum radius of first section 160 is preferably 0.750 in. The smallest radius of middle section 164 is preferably 0.610 in. Gripping section 66 therefore slopes inwardly from first section 160 to middle section 164, and then outwardly from middle section 164 to third section 162.

The inventors have found that, surprisingly, the combination of the reverse radius gripping section and the angled bulkhead section produce a grip and feel that is greater than the sum of what would be expected. The inventors believe that the reverse radius of the gripping section produces a better feel in a dental professional's hand because the center of gravity of the gripping section is closer to the point of contact with the hand of the dental professional, allowing for better balance. Additionally, the angled bulkhead section reduces the moment of the handpiece 20 in the dental professional's hand, further improving the balance of the tool.

In use, handpiece 20 is connected to air tube 130 by screwing sleeve 132 onto bulkhead section 30. Prophy angle 114 is attached to chuck section 106 and is aligned properly by use of locator pin 116. The dental professional activates air supply 144 using foot pedal 146, which causes compressed air to flow through air supply lumen 138, through air supply tube 46, and into air intake port 76. The flow of air causes air turbine 74 to rotate collet 86. Exhaust air flows out of air turbine 74 through air exhaust port 78, through air exhaust tube 48 and through air exhaust lumen 140 to the atmosphere. Accordingly, the dental professional can control the rotation of collet 86 using foot pedal 144.

The rotation of collet 86 causes driving gear 118 in prophy angle 114 to rotate. Driving gear 118 rotates driven gear 122, which, in the illustrated embodiment, rotates prophy angle paste cup 120.

Alternatively, the air supply/turbine system as described above may be replaced with an electric motor system, keeping the reverse radius grip and an angled bulkhead arrangement. Instead of air tubes to the bulkhead section, a power cord delivers electricity to a motor within the gripping section.

While preferred embodiments of the present invention are shown and described, it is envisioned that those skilled in the art may devise various modifications of the present invention without departing from the spirit and scope of the appended claims.

We claim:

1. An improved handpiece having a distal end and a proximal end, the handpiece comprising:
nosecone at the distal end,
a bulkhead section at the proximal end, and
a power section between the nosecone and the bulkhead section, the nosecone being connection to a first end of the power section and the bulkhead section being connected to a second end of the power section,
the power section having a reverse radius grip and
the bulkhead section being angled relative to the power section.

2. The handpiece of claim 1, wherein
the power section has a first end proximal to the bulkhead section and a second end distal to the bulkhead section;
the power section comprises a gripping section at the power section first end and an attachment section at the power section second end;
the gripping section comprises a first section proximal to the bulkhead section, a third section proximal to the nosecone, and a middle section between the first section and the second section, the minimum radius of the middle section being less than the maximum radius of the first section and of the maximum radius of the third section.

3. The handpiece of claim 2, wherein the gripping section encloses an air turbine comprising an air intake port and an air exhaust port.

4. The handpiece of claim 3, wherein the attachment section comprises a swivel surface, the swivel surface comprising a cylindrical tube having an outer diameter, the tube comprising a circumferential slot and a key, the key having an outer diameter, the key outer diameter being greater than the tube outer diameter; and
wherein a collet extends from the air turbine axially through the swivel surface, the collet comprising a cylindrical structure and having an end proximal to the air turbine and an end distal to the air turbine, the collet being rotated by the air turbine, the collet proximal end being solid, and the collet further comprises a bore at the collet distal end and crimped surfaces, the crimped surfaces extending into the bore.

5. The handpiece of claim 4, wherein the bulkhead section comprises a hollow casing having a first end and a second end, the casing first end being proximal to the power section and the casing section second end being distal to the power section, and an air supply tube and an air exhaust tube run through the casing, the air supply tube engaging the air intake port and the air exhaust tube engaging the air exhaust port.

6. The handpiece of claim 5, wherein the nosecone has a first end and a second end, the nosecone first end being proximal to the power section and the nosecone second end being distal to the power section, the nosecone comprising a conic section at the nosecone second end and a chuck section extending from the conic section toward the nosecone second end, the conic section further comprising a cone-shaped solid structure having a cylindrical bore extending axially therethrough, the conic section bore having an inner diameter, the conic section bore inner diameter being greater than the swivel surface outer diameter, wherein the swivel surface fits securely within the conic section bore.

7. The handpiece of claim 6, wherein the conic section further comprises a circumferential slot configured to receive the key.

8. The handpiece of claim 7, wherein the chuck section comprises a sold cylindrical structure having an axial bore, the chuck section bore configured to hold the collet and to allow the collet to rotate freely within the chuck section bore, the chuck section having an outer diameter sufficient to hold a prophy angle with a friction fit, the chuck section further comprising a radially-protruding locator pin configured to hold the prophy angle at a preselected location on the nosecone.

9. The handpiece of claim 8, wherein the prophy angle comprises a driving gear, the driving gear configured to fit into the collet bore, the crimped surfaces producing a friction fit of the driving gear in the collet bore.

10. The handpiece of claim 9, wherein the driving gear rotates a driven gear and the prophy angle has a paste cup, the driven gear rotating the paste cup.

11. The handpiece of claim 10, further comprising an air tube, the air tube having a first end and a sleeve at the first end, the sleeve connecting to the bulkhead section, the air tube further comprising an air supply lumen and an air exhaust lumen, the air supply lumen configured to connect to the air supply tube and the air exhaust lumen configured to connect to the air exhaust lumen.

12. The handpiece of claim 11, wherein the air tube has a second end, the air tube connecting at the air tube second end to a compressed air supply.

13. The handpiece of claim 12, wherein an axial line through the nosecone and the power section forms an angle of approximately 45 degrees to an axial line through the bulkhead section.

14. The handpiece of claim 1, wherein an axial line through the nosecone and the power section forms an angle of approximately 45 degrees to an axial line through the bulkhead section.

15. An improved handpiece having a distal end and a proximal end, the handpiece comprising:
a nosecone at the distal end,
a bulkhead section at the proximal end, and
a power section between the nosecone and the bulkhead section, the nosecone being connection to a first end of the power section and the bulkhead section being connected to a second end of the power section,
the power section having a reverse radius grip,
wherein an axial line through the nosecone and the power section forms an angle of approximately 45 degrees to an axial line through the bulkhead section,
the power section has a first end proximal to the bulkhead section and a second end distal to the bulkhead section;
the power section comprises a gripping section at the power section first end and an attachment section at the power section second end;
the gripping section comprises a first section proximal to the bulkhead section, a third section proximal to the nosecone, and a middle section between the first section and the second section, the minimum radius of the middle section being less than the maximum radius of the first section and of the maximum radius of the third section;
wherein the gripping section encloses an air turbine comprising an air intake port and an air exhaust port,
wherein the attachment section comprises a swivel surface, the swivel surface comprising a cylindrical tube having an outer diameter, the tube comprising a circumferential slot and a key, the key having an outer diameter, the key outer diameter being greater than the tube outer diameter;
wherein a collet extends from the air turbine axially through the swivel surface, the collet comprising a cylindrical structure and having an end proximal to the air turbine and an end distal to the air turbine, the collet being rotated by the air turbine, the collet proximal end being solid, and the collet further comprises a bore at the collet distal end and crimped surfaces, the crimped surfaces extending into the bore;
wherein the bulkhead section comprises a hollow casing having a first end and a second end, the casing first end being proximal to the power section and the casing section second end being distal to the power section, and an air supply tube and an air exhaust tube run through the casing, the air supply tube engaging the air intake port and the air exhaust tube engaging the air exhaust port;
wherein the nosecone has a first end and a second end, the nosecone first end being proximal to the power section and the nosecone second end being distal to the power section, the nosecone comprising a conic section at the nosecone second end and a chuck section extending from the conic section toward the nosecone second end, the conic section further comprising a cone-shaped solid structure having a cylindrical bore extending axially therethrough, the conic section bore having an inner diameter, the conic section bore inner diameter being greater than the swivel surface outer diameter, wherein the swivel surface fits securely within the conic section bore;
wherein the conic section further comprises a circumferential slot configured to receive the key;
wherein the chuck section comprises a sold cylindrical structure having an axial bore, the chuck section bore configured to hold the collet and to allow the collet to rotate freely within the chuck section bore, the chuck section having an outer diameter sufficient to hold a prophy angle with a friction fit, the chuck section further comprising a radially-protruding locator pin configured to hold the prophy angle at a preselected location on the nosecone
wherein the prophy angle comprises a driving gear, the driving gear configured to fit into the collet bore, the crimped surfaces producing a friction fit of the driving gear in the collet bore;
wherein the driving gear rotates a driven gear and the prophy angle has a paste cup, the driven gear rotating the paste cup;
the handpiece further comprising an air tube, the air tube having a first end and a sleeve at the first end, the sleeve connecting to the bulkhead section, the air tube further comprising an air supply lumen and an air exhaust lumen, the air supply lumen configured to connect to the air supply tube and the air exhaust lumen configured to connect to the air exhaust lumen;
wherein the air tube has a second end, the air tube connecting at the air tube second end to a compressed air supply;
wherein an axial line through the nosecone and the power section forms an angle of approximately 45 degrees to an axial line through the bulkhead section; and
wherein an axial line through the nosecone and the power section forms an angle of approximately 45 degrees to an axial line through the bulkhead section.
